(19) United States
(12) Patent Application Publication
(10) Pub. No.: US 2003/0017285 A1
(43) Pub. Date: Jan. 23, 2003

(54) Heat shrinkable film and jacket

(75) Inventors: Dan Cantrell, Littleton, CO (US); George Kayser, Newark, CA (US)

Correspondence Address: TYCO ELECTRONICS CORPORATION, MAIL STOP R20/2B, 307 CONSTITUTION DRIVE, MENLO PARK, CA, 94025, US

(73) Assignee: Tyco Electronics Corporation, Middletown, PA

(21) Appl. No.: 09/906,327

(22) Filed: Jul. 16, 2001

(51) Int. Cl. B32B 1/06

(52) U.S. Cl. 428/35.1

(57) ABSTRACT

This invention relates to a heat shrinkable blown film. In addition, unique applications for such heat shrinkable films have been invented, as well as articles using heat shrinkable films. The film shrinks about seven percent to about twelve percent in a machine direction and about eighteen percent to about twenty five percent in a transverse direction when heated at about 135° C. and can be used as a heat shrinkable wrapping for articles with a variety of shapes.

### FIELD OF THE INVENTION

The present invention relates to a heat-shrinkable film and a method for using the film as a jacket to wrap structures.

### BACKGROUND

The need for heat-shrinkable polymer films is well established. Particularly there is a need for heat-shrinkable films that have greater shrinkage in one direction over the other.

Polyolefin films, especially polyethylene films, are frequently formed as blown films. Film blowing involves continuously extruding a polymer melt through an annular die to form a continuous cylinder of viscous polymer, and then expanding the diameter of the cylinder through, for example, a pressure differential between the inside and outside of the cylinder. Typically, the extruded film is extruded in an upward fashion. As the film moves upward, air is blown into the film which expands the film into a tubular shape. The tube is generally closed at some distance above the die, with a pair of nip rolls. The resulting film is a thin walled, tubular roll of film.

Polymer films are also often crosslinked to obtain various desirable properties such as increased strength and toughness, greater resistance to solvents and other harmful chemicals, improved high-temperature performance, stabilized electrical properties and elastic memory. For purposes of heat-shrink products, the property of elastic memory is the most important. Crosslinking provides the elastic memory that enables heat-shrink films the ability to recover upon installation with heat. Because they have been crosslinked, these films can easily shrink to fit a wide variety of sizes or shapes.

Polymer products are usually crosslinked by either radiation or chemical means. These two methods achieve many of the same results, but they are very different. In radiation crosslinking, an already fabricated polymer product is exposed to a radiation source, such as a high-energy electron beam; this beam activates the cross-linking process. In chemical crosslinking, chemical agents such as peroxides are added to a polymer compound. The polymer compound is then heated to activate the crosslinking process and, at the same time, the product is fabricated.

Heat shrinkable materials are used in dozens of products such as heat-shrink tubing, pipeline coatings, and telecommunications splices. These films are ideal for these applications because of their durable, yet flexible structure. Heat shrinkable films can be used in a number of other products which require a tight, flexible, yet strong wrapping.

A problem with heat shrinkable films of the prior art is that they shrink significantly both in the machine direction, i.e. the direction of extrusion and also in the transverse direction, i.e. the direction perpendicular to the direction of extrusion. This is especially problematic when trying to wrap tube-like objects where it is desirable to have a film that only shrinks in one direction. Using a heat-shrinkable film that shrinks in both directions for such an application is not efficient and results in having to use more film than necessary, since there is both shrinkage around the circumference and around the length of the tube.

Therefore, it is an object of the present invention to provide a heat-shrinkable film that has significant shrinkage in one direction while substantially maintaining its size in the other direction when the film is exposed to heat. The present invention addresses these needs as well as other problems associated with heat shrinkable films and manufacturing processes. The present invention also offers further advantages over the prior art, and solves problems associated therewith.

### BRIEF SUMMARY

According to the present invention a heat shrinkable blown film is provided that overcomes many of the foregoing problems. In addition, unique applications for such heat shrinkable films have been invented and articles using heat shrinkable films.

In one aspect, the invention is a heat shrinkable polymer blown film that shrinks about seven percent to about twelve percent in a machine direction and about eighteen percent to about twenty-five percent in a transverse direction when heated to at least 135° C.

In another aspect, the invention is a method for wrapping structures that includes the steps of providing a roll of heat shrinkable film, wherein said film rapidly shrinks about eighteen to about twenty-five percent in a transverse direction and shrinks less than about two percent in a machine direction when heated to a temperature of about 135° C. for between about ten and thirty seconds; wrapping said film about a structure; fusing said film to itself; and exposing said film wrapped structure to a temperature of about 135° C. for between about ten and thirty seconds, thereby shrinking the film about eighteen to about twenty-five percent in the transverse direction and less than about two percent in the machine direction.

The invention provides the foregoing and other features, and the advantages of the invention will become further apparent from the following detailed description of the presently preferred embodiments, read in conjunction with the accompanying drawings. The detailed description and drawings are merely illustrative of the invention and do not limit the scope of the invention, which is defined by the appended claims and equivalents thereof.

### BRIEF DESCRIPTION OF SEVERAL VIEWS OF THE DRAWINGS

In the drawings, in which like reference numerals indicate corresponding parts or elements of preferred embodiments of the present invention throughout several views:

FIG. 1 is a schematic representation of the components of a preferred blown film extrusion line for the manufacture of a heat shrinkable film of the present invention;

FIGS. 2a-2g are a schematic representation of a process for using the heat shrinkable film of the present invention as a jacket for an air curtain; and

FIG. 3 is a schematic representation of an air curtain wrapped with a heat shrinkable film of the present invention.

### DETAILED DESCRIPTION

The present invention relates to a heat-shrinkable film 16 and applications thereof. Particularly, the invention relates to a heat-shrinkable film 16 that shrinks significantly more in one direction (the transverse direction) compared to the other direction (the machine direction). The machine direction is defined as the direction in which the polymer is extruded. The transverse direction is the direction perpendicular to the machine direction.

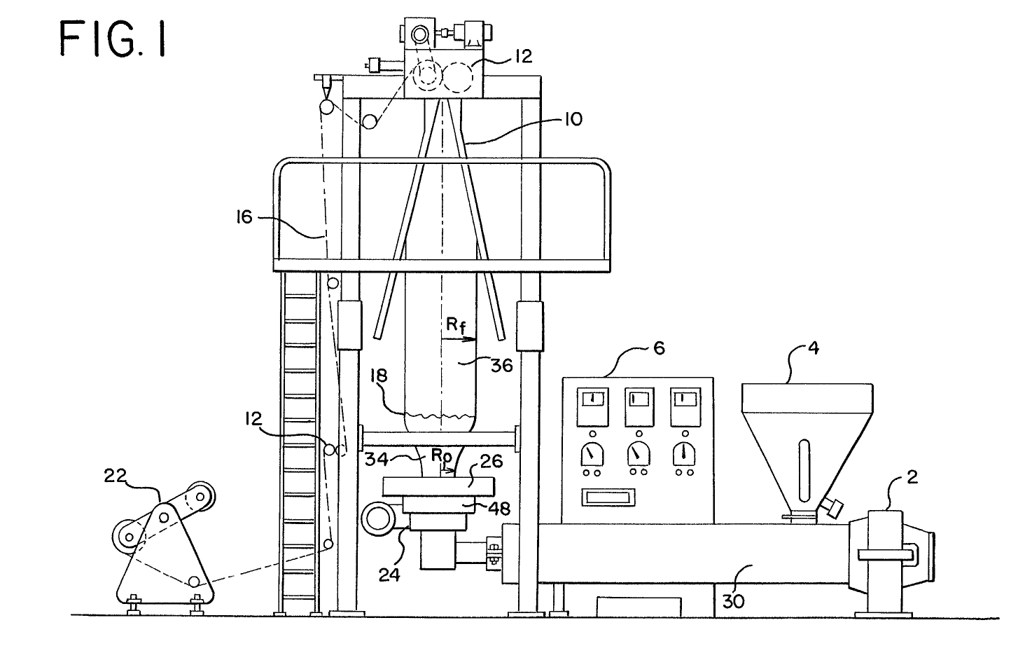

As illustrated in FIG. 1, a tube extrusion blown film process is preferably used to manufacture the heat shrinkable film 16. The film 16 can also be processed using an extrusion and tentering process or a cast film process, both of which are known in the art. The starting material for the process is a polymer material, preferably a low-density polyethylene such as Petrothene NA-191 available from Equistar Corporation. To extrude the polymer, pellets of polymer material are fed into the hopper 4 of the extruder 30. The hopper 4 then feeds the polymer material into a screw (not shown). As the drive and reducer 2 turn the screw, the polymer material is forced forward and toward the far end of the barrel. Heat for the extrusion process can be provided through conventional means, known to one of ordinary skill, such as by mounting heaters around the external surface of the extrusion chamber 30. The polymer material melts and is mixed to a substantially homogeneous temperature and melt viscosity as it moves along the screw. The line speed, draw ratio, temperatures, and other parameters of the process are preferably predetermined and controlled by the control panel 6.

The melted polymer material is then extruded through a die 24. The die 24 has a small hole or opening that gives the film 16 its shape. The die 24 used in the present invention is an annular shaped die 24 which gives the molten polymer 34 a tube-like shape as it exits the die 24.

The tube of molten polymer 34 is blown up and kept in a tube-like shape by creating a pressure differential between the pressure inside the tube and the pressure outside the tube. One preferred method to create the pressure differential is to use an air supply 42 that blows air into the tube. As air is blown into the tube, the moving tube is stretched and inflated by internal air pressure, which is higher than the atmospheric pressure outside the tube.

The molten tube of polymer material then cools as it moves upward. The cooling process can be expedited by blowing a current of cooling air around the external surface of the tube with an air ring 26. In some cases, in addition to the external cooling air, an internal air cooling system may be provided. Finally, in some other cases, especially for a thick tube, cooling is achieved by water spray or a ring. As the molten polymer material 34 cools, it goes through a phase transition and turns to a solid polymer film 36. The point where the molten polymer film 34 crystallizes and becomes a solid is defined as the frost line or crystallization line. Beyond the frost line the deformation of the tube is negligible, and the tube consists of one phase material only, the solidified polymer.

The film tube 36 is then collapsed to a flat sheet. A preferred means for collapsing the tube is by using a collapsing frame 10. Nip rolls 12 form an air-tight seal at the upper end of the tube and collapse the tube into a dual layered flat sheet. The film 16 is then wound into a roll of film 16 by a winder 22. The film 16 is then crosslinked. The crosslinking may be done immediately before the step of winding the film 16 and can be included as part of the continuous process of extruding and blowing the film 16. The crosslinking may also be done as a separate step after the film 16 is wound into a roll.

The film blowing process has free boundaries, and the flows are predominantly elongational. The film blowing process imparts unequal biaxial orientation to the film. The two axes of orientation are the axial or machine direction, which is the direction in which the tube is drawn and the circumferential or transverse direction due to the blowup of the tube. The mechanical properties of the blown film 16 are nearly uniform in both directions as a result of bi-axial orientation.

To make the heat shrinkable film of the present invention, several different parameters must be kept in the desired ranges. One important parameter is the blow up ratio. The blow up ratio (BUR) is defined as the ratio of the final tube radius, R_{f}, to the initial tube outer radius just downstream of the annular die 24, Rₒ.

BUR=R_{f}/Rₒ

In conventional blown film processes, the blow up ratios range from one to three. It has been found that increasing the blow up ratio increases the shrinkage in the transverse direction. However, increasing the blow up ratio also makes the film tube unstable. In the present embodiment, the preferred blow up ratio is kept between about four to about six.

The draw ratio is also an important parameter for the method of the present invention. The draw ratio (Dᵣ) is defined as the ratio of the take-up speed (V) of the polymer to the die extrusion speed (vₒ):

Dᵣ=V/vₒ

The draw ratio has an effect on the modulus of elasticity of the film 16. Generally the modulus of elasticity in the machine direction increases and the modulus of elasticity in the transverse direction decreases as the draw ratio is increased. In a preferred embodiment of the present invention the draw ratio is about 3.0 to about 3.5.

Another important parameter for making the heat shrinkable film is the swell ratio. As the molten polymer 32 exits the opening in the die 24, it changes thickness. The swell ratio is defined as the ratio of the thickness of the molten polymer 32 directly after exiting the die 24 (Tₚ) to the thickness of the opening of the die 24 (Tₒ):

SR=Tₚ/Tₒ

In a preferred embodiment of the present invention, the swell ratio is preferably kept less than about two. The two main parameters that affect the swell ratio are the draw ratio and the configuration of the die 24.

In the process of the present invention, the temperature of the polymer material in the die 24 is generally between about 170° C. to about 200° C. The temperature of the polymer inside the extrusion chamber is generally between about 135° C. to about 175° C.

Another important parameter for making the heat shrinkable film is the way the polymer is crosslinked. Crosslinking gives the polymer a “memory” that causes the polymer to recover to near its original shape when exposed to heat. The preferred method of crosslinking the polymer is through radiation means. A high-energy electron beam is used to initiate crosslinking in the polymer. An electron accelerator may be used to generate the electron beam. The radiation crosslinking is a carried out in a substantially closed environment. Preferably, the radiation crosslinking is done within a concrete vault three to seven feet thick. The upper part of the vault is called the “vessel,” and the lower part of the vault where the irradiation actually takes place is called the “beam cell.” The film 16 is fed through the vault by capstans or guide rolls. The amount of irradiation affects the properties of the film 16. It was found that increasing the amount of irradiation decreased the shrinkage both in the machine direction and in the transverse direction. However, it was found that increasing the irradiation decreased the shrinkage in the machine direction to a greater extent compared to the decreased shrinkage in the transverse direction. The preferred amount of radiation is an electron beam dose of about 5 megarads to about 20 megarads.

The film 16 of the present invention shrinks when it is first heated and has several useful and distinct properties. In one embodiment, the film 16 of the present invention shrinks about twice as much in the transverse direction compared to the shrinkage in the machine direction. Films of the prior art have greater shrinkage in the machine direction compared to the shrinkage in the transverse direction, whereas the film of the present invention shrinks significantly more in the transverse direction. Preferably, the film 16 shrinks about seven percent to about twelve percent in the machine direction compared to about eighteen percent to about twenty five percent in the transverse direction when the film 16 is heated at about 135° C. for about three minutes. The film 16 is preferably about 75 microns to about 150 microns thick.

Furthermore, when the film 16 is heated it shrinks much more rapidly in the transverse direction compared to the machine direction. A preferred embodiment of the film 16 shrinks about eighteen percent to about twenty five percent in the transverse direction in about ten seconds when the film 16 is heated in an oven at about 135° C. Whereas, the film 16 takes about three minutes to shrink about seven percent to about twelve percent in the machine direction when the film 16 is heated in an oven at about 135° C. As a result, by limiting the heating to between about ten and thirty seconds, one obtains the benefit of a material that substantially shrinks in only the transverse direction.

Another distinguishing and important property of the present invention is that the film 16 can be fused to itself using heat fusion. While non-crosslinked polymer film will fuse to itself, the fused portion of the film will be approximately the same thickness as the rest of the film. Furthermore, crosslinked polymer films of the prior art will not fuse through heat fusion because crosslinking increases the ability of polymer products to maintain structural integrity at high temperatures and therefore prevents fusing. When exposed to temperatures above their melting point, crosslinked materials will soften and melt but not flow. The film 16 of the present invention, unlike most crosslinked polymers, is capable of fusing together with heat fusion. Furthermore, the fused portion of the film 16 of the present invention is approximately twice as thick as the unfused portion of the film 16. This provides greater strength and flexibility than a fused polymer film 16 that is not crosslinked.

The following examples show other preferred embodiments and advantages of the present invention disclosed herein:

### EXAMPLE

A polymer compound composed of 86.4% polyethylene-petrothene NA 191 and 13.6% of a blend of an additive and colorant concentrate was made into a blown film and crosslinked using a blown film extrusion process and irradiated with an electron beam under the following conditions

Extrusion Conditions:

Extruder: 1-¼ Killion

Barrel Temperature:

| Zone 1: | 179° C. |
|---|---|
| Zone 2: | 188° C. |
| Zone 3: | 188° C. |
| Film Die: | 188° C. |
| Screw Type: | Saxton |
| Head Pressure: | 28,269 kPa |
| Film Speed: | 1.95 m/min |
| Blow up ratio: | 5.64 |

Film Dimensions:

Width: 11.1125 cm

Thickness: 0.0089 cm to 0.0102 cm

Shrinkage Results:

| Megarads | % Machine Direction | % Transverse Direction |
|---|---|---|
| 5 | −17 | −37 |
| 10 | −13 | −28 |
| 15 | −8 | −24 |
| 20 | −8 | −20 |
| 25 | −8 | −18 |

The present invention has many uses and advantages over the prior art. A film 16 that substantially shrinks in one direction can have many different advantages and uses, of which some preferred uses and advantages are described herein. First, the heat shrinkable film 16 can be used as a tight wrapping or seal around various shaped articles. For example, the film 16 can be particularly useful as heat shrink tubing, pipeline coating, and electrical splices. The film 16 also has a durable, yet flexible structure which makes it ideal for such uses. The film 16 can also be used to provide a wrapping on irregular shaped objects.

A film 16 that shrinks substantially in only the transverse direction saves material and decreases manufacturing costs. For example for tube wrapping, heat shrinkable films that shrink in both directions would shrink around the circumference of the tube and also along the length of the tube. With the film 16 of the present invention, there is no shrinkage along the length of the tube and therefore less film 16 needs to be used to wrap such structures.

A heat shrinkable film 16 provides an easy way to put a tight wrapping on a structure. Since the film 16 is in an expanded state prior to heating, it can easily be placed over the article to which it is being applied and then recover to fit tightly by applying heat.

One particularly useful application of the film 16 of the present invention is as ajacket for an air curtain 66. In the prior art, the jacket is usually a sock shaped material. The air curtain 66 is stuffed into the sock. When the air curtain 66 is activated and inflated, it bursts through the sock and provides an air cushion around the side interior of an automobile.

The use of a heat shrinkable material for air curtains allows for easy integration of the air curtains to the existing componentry of the automobile due to the pliable and soft nature of the air curtain 66 and film 16, which can be somewhat molded to the contour of the space available for the air curtain 66. The film 16 of the present invention provides an “off-the-shelf” cover material that can be used to greatly shorten the time required for air curtain module design. In the past, module cover tooling has had one of the longest lead times in module design. The use of a heat shrink material as a jacket eliminates the inherent development constraints caused by such long lead times. Using the heat shrinkable film 16 as a jacket is also cost effective and more efficient than the prior art enclosures.

In one embodiment, the process begins with providing a roll of heat shrinkable film 16 of the present invention. The necessary length is determined by calculating the amount of film 16 needed to wrap around an air curtain 66 of a given size. The film 16 used in this application is preferably a cautionary color such as yellow, orange, fluorescent green and the like.

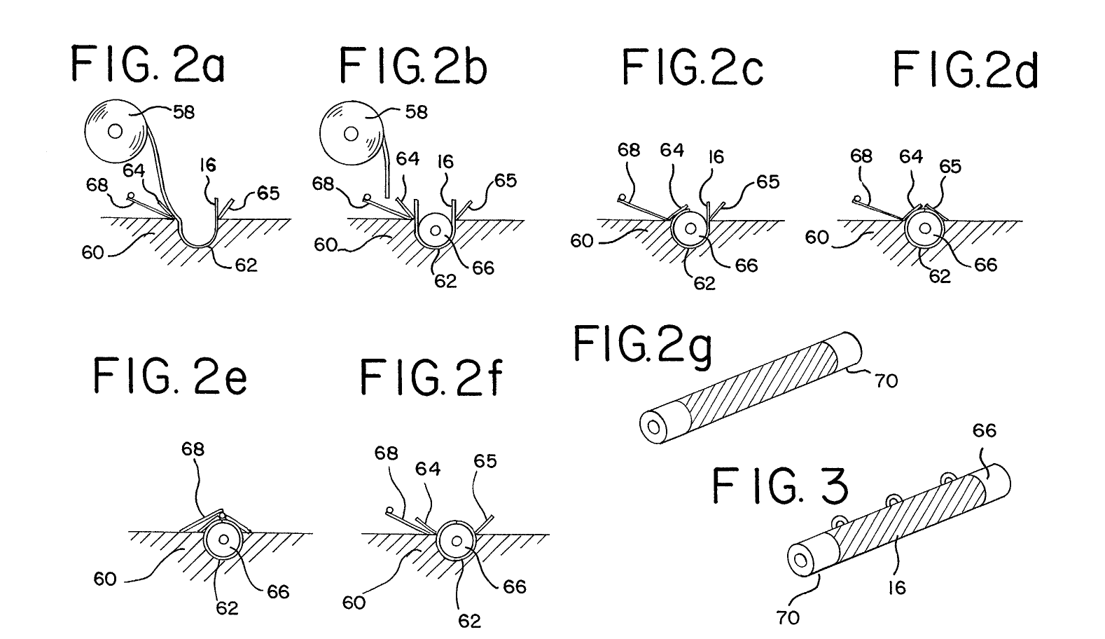

The film 16 is then dispensed and cut at a predetermined length and positioned around the curtain as illustrated in FIG. 2. A sealing bar 68 is then lowered onto the film 16 which applies heat and fuses the film 16.

The air curtain assembly 70 as illustrated in FIG. 3, is then heated to about 135° C. for between about 10 and 30 seconds to shrink the film 16 and create a tight jacket around the curtain. A preferred way of heating the film 16 is to expose the air curtain assembly 70 to infrared light, which is attracted to colored film 16. Another way to heat the curtain assembly is to place the assembly 70 on a conveyor belt traveling at about 1.22 m/min in an oven at a temperature of about 600° C.

Using the film 16 of the present invention as a jacket for air curtains has many advantages. When the air curtain 66 is inflated, the film jacket of the present invention breaks out through perforations and there are no break away threads. This provides the ability to predict exactly where the jacket will break.

The film jacket of the present invention is also very durable and provides an easier method to wrap air curtains. The film 16 also is translucent, which allows for the ability to read a bar code through the film. The film may also be flame retarded by adding a flame retardant.

It is contemplated that numerous modifications may be made to the heat shrinkable film and processes of the present invention without departing from the spirit and scope of the invention as defined in the claims. For example, the film may be used to provide a seal. Also, the step of blowing the molten material into a tube may be carried out in a water bath or vacuum box for large tubing products. Accordingly, while the present invention has been described herein a relation to several embodiments, the foregoing disclosure is not intended or to be construed to limit the present invention or to exclude any such other embodiments, arrangements, variations, or modifications and equivalent arrangements. Rather, the present invention is limited only by the claims appended hereto and the equivalents thereof.

1. A heat shrinkable polymer blown film that shrinks about seven percent to about twelve percent in a machine direction and about eighteen percent to about twenty-five percent in a transverse direction when heated to at least 135° C.

2. The film of claim 1 wherein said film comprises a low density polyethylene polymer.

3. The film of claim 1 wherein the film shrinks about seven percent to about twelve percent in the machine direction when said film is heated in an oven at about 135° C. for about three minutes.

4. The film of claim 1 wherein the film shrinks about eighteen percent to about twenty-five percent in a transverse direction when said film is heated in a oven at about 135° C. for between about ten and thirty seconds.

5. The film of claim 1 wherein the film is cross-linked by irradiation.

6. The film of claim 1 wherein the film is fusable over itself using heat fusion.

7. The film of claim 1 wherein the film does not decrease in thickness in the area where said film is fused over itself.

8. A method for wrapping structures comprising:
(a) providing a roll of heat shrinkable film, wherein said film rapidly shrinks about eighteen to about twenty-five percent in a transverse direction and shrinks less than about two percent in a machine direction when heated to a temperature of about 135° C. for about between ten and thirty seconds;
(b) wrapping said film about a structure;
(c) fusing said film to itself;
(d) exposing said wrapped structure to a temperature of about 135° C. for between about ten and thirty seconds,
thereby shrinking the film about eighteen percent to about twenty-five percent in the transverse direction and less than about two percent in the machine direction.

9. The method of claim 8 wherein said structure is an inflatable air curtain.

10. The method of claim 8 wherein said inflatable air curtain is rolled into a substantially cylindrical structure.

11. The method of claim 8 wherein said film shrinks around the circumference of said structure.

12. The method of claim 8 wherein said film acts as a jacket for said structure.

13. The method of claim 8 wherein said film is heated at about 135° C.

14. The method of claim 8 wherein said film is placed on a conveyor belt traveling at about 1.22 m/min in an oven heated to about 600° C.

15. A structure wrapped with the film of claim 1.

16. A film wrapped structure made by the method of claim 8.

17. An air curtain having a jacket that comprises the heat shrinkable polymer blown film of claim 1.

18. An automobile having an air curtain made by the method of claim 8.

19. A heat shrinkable film that shrinks faster in the transverse direction compared to the machine direction when said film is heated.

20. A heat shrinkable film that has greater shrinkage in the transverse direction compared to the shrinkage in the machine direction when said film is heated.
